(19) United States
(12) Patent Application Publication
(10) Pub. No.: US 2021/0108835 A1
(43) Pub. Date: Apr. 15, 2021

(54) MOBILE COOLING SYSTEM WITH VARIABLE SPEED FAN

(71) Applicants: Glen A Wind, SR., Houston, TX (US); Austin Traweek, Houston, TX (US)

(72) Inventors: Glen A Wind, SR., Houston, TX (US); Austin Traweek, Houston, TX (US)

(73) Assignee: Bold Production Services LLC, Houston, TX (US)

(21) Appl. No.: 17/003,717

(22) Filed: Aug. 26, 2020

Related U.S. Application Data
(60) Provisional application No. 62/892,987, filed on Aug. 28, 2019.

(51) Int. Cl. F25B 27/00; F25B 41/40; H02S 10/40

(52) U.S. Cl. CPC F25B 27/002; F25B 2327/00; H02S 10/40; F25B 41/40

(57) ABSTRACT

A mobile cooling system comprising a heat exchanger for cooling fluids, configured for efficient and cost-effective transportation without wide-load restrictions over highways. The mobile cooler can include a cooler, a motor capable of operating a fan at variable speeds, a control module and telemetry system for remote operation and monitoring, and a solar panel to provide alternative energy, all mounted on a trailer. The cooler is configured to use a fan blowing air to reduce the temperature of a fluid flowing through cooling tubing of the cooler. An engine driver may be located on the same or a separate trailer capable of supplying the cooling system with electrical power. Multiple mobile cooling systems may be efficiently utilized for operations requiring cooling of multiple fluid streams.

### CROSS REFERENCE TO RELATED APPLICATIONS

This application claims priority to U.S. Provisional Patent Application Ser. No. 62/892,987, filed on Aug. 28, 2019.

### BACKGROUND OF INVENTION

### Field of Use

The present invention provides an improved system, method and apparatus for cooling fluids for various applications, for example, in one embodiment, as part of oil and gas cooling production systems. In particular, the present invention relates generally to a mobile trailer-mounted forced-air fluid cooling system, which can be efficiently transported to multiple sites. The disclosed cooling system is capable of efficiently cooling fluids to targeted temperatures by using a variable speed drive and an automated process, which can be monitored and controlled remotely.

### Description of Related Art

Hydrocarbon Fluid Cooling Equipment

Reservoir fluid extracted from oil and gas wells consists primarily of water, oil and gas. The reservoir fluid arrives at the surface at a well-head at high temperature and pressure, and must be treated, processed and separated by production equipment prior to its commercial use and transportation. Conventionally, for various reasons, hydrocarbon reservoir fluids are not transported long distances as a mixed stream, but instead are separated into their gas and liquid phases by surface processing equipment located in close proximity to the wells.

Wells in shale plays (a type of reservoir that has become increasingly available and economic through technological improvements in horizontal drilling and hydraulic fracturing) tend to reach vertical depths of over 10,000 feet. Bottom hole pressures at such depths may reach 10,000 psig with temperatures of fluids ranging above 300° F., whereas the maximum-allowed temperature for gas transported in a typical surface gas pipeline may range from 130°-140° F. Accordingly, surface production equipment is used to reduce the temperature of reservoir fluids.

Air cooled heat exchanger (ACHEX) equipment has been used for decades along with various other equipment to reduce the temperature of hydrocarbon reservoir fluids in upstream (at or near well sites) as well as at times midstream (along pipelines) and downstream (at refineries). Reservoir fluids may be cooled for a variety of reasons at or near the wellsite, including to allow further processing and separation of gas and liquids, to help reduce the water content of the fluid (prior to dehydration), to aid in recovery of natural gas liquids (NGLs), to meet pipeline temperature specifications for gas, and/or to reduce volatility of the fluids. Use of ACHEX equipment can increase production efficiencies and recovery of hydrocarbons.

Traditionally cooling operations for hydrocarbons in the field have been performed by ACHEX equipment, otherwise known as “coolers,” installed at a well site. Conventional coolers receive reservoir fluid streams that flow from a wellhead and pass that stream through tubing where air is blown over the tubes to lower the temperature of the stream by a fan driven by a prime mover, such as a natural gas driven engine or other engine driver. In such systems, the forced air flow effects heat exchange from the fluids travelling through the tubing, thereby reducing the outlet temperature of the stream. Typical commercial ACHEX equipment has throughput capacities for fluids of 6,000-7,000 bbl/d or 20-30 MMscfd and pressure ratings up to 1,440 psig.

As far as their transportation over highways, conventional coolers used for oil and gas field production operations are considered “wide loads” based upon their size and weight, and are subject to various federal and state transportation regulations increasing the expense and timing to get such equipment to the well sites. In addition, cranes and other heavy machinery are usually required to move, set up and level conventional coolers once they arrive on location. Therefore, conventional coolers require substantial cost and time to transport and set up on site.

Further, the engines driving the fans in conventional coolers are typically operated in either an on or off mode, without the ability to operate the motors at variable speeds to achieve more rapid and precise control of the outlet temperature of the fluid stream, as well as more efficient use of energy powering the engines. While the fan blowing air across heat exchange tubing in conventional coolers allows for continuous cooling of fluids, the inability to vary fan speed in conventional ACHEX equipment limits the operator's ability to more precisely control the temperature of the outlet stream and energy inefficiency. Furthermore, the continual operation of such conventional ACHEX equipment leads to more frequent service and maintenance costs.

Conventional coolers used at well sites, often single units, have also been inadequate to provide efficient cooling for multi-well pad sites, where each well at the site may be flowing with different characteristics that requires individualized cooling needs. In addition, conventional coolers have lacked the capability to be remotely monitored, managed and controlled.

Accordingly, there is a need for an improved mobile cooler capable of fitting on a trailer that meets or exceeds specifications in order to be efficiently transportable without being classified as a “wide load” on highways and roads at minimum cost and time to deploy. There is further need for such a cooling system that can achieve more precise and efficient cooling, including for multi-well sites, as claimed through the use of a variable speed fan with automated temperature controller, with the ability to adjust and monitor operations remotely.

SUMMARY OF INVENTION

In a preferred embodiment, the cooler system of the present invention is designed to be fully mobile and capable of being monitored remotely. The system includes an industrial cooler mounted on a gooseneck trailer. The trailer may include leveling members, such as manual and/or hydraulic jacks, to permit leveling the trailer when located on site. A person of ordinary skill in the art will appreciate that other configurations of the disclosed system are possible without departing from the broader scope of this disclosure.

An object of the present cooler system invention is to be fully portable and capable of being automatically controlled and monitored remotely 24/7, as well as that can communicate with supervisory control and data acquisition (SCADA) control systems and peripheral devices such as programmable logic controllers (PLC).

Another object of the present invention is to have a cooler system that includes customized proportional-integral-derivative (PID) control loops and coded algorithms.

Another object of the present invention is to provide a plurality of mobile coolers capable of being powered by a single generator for multi-well pad locations and is rugged enough for harsh environments.

Another object of the present invention is to have a cooler system that senses inlet and outlet temperature and automatically controls cooling output through controlling fan speed and adjusting vent louvers to achieve improved temperature stabilization.

Another object of the present invention is to monitor any vibration of the system and to shut down the cooler if excessive vibration is detected.

Another object of the present invention is to provide a mobile cooler system capable of reducing energy consumption and maintenance requirements.

Another object of the present invention is to provide a plurality of mobile coolers capable of running off either the electrical grid or an on-site generator, but also with capability to power communications off a solar power system when other power is not available.

Another object of the present invention is to provide a mobile cooler on a goose-neck trailer capable of being pulled by a regular pick-up truck, which meets or exceeds DOT and non-“wide load” specifications for cost effective and efficient transportation.

Another object of the present invention is to provide real-time alarms, warnings, and call-outs to operators for faster and more prepared response to various operational upsets.

### SUMMARY OF DRAWINGS

Some embodiments of the present invention are illustrated as an example and are not limited by the figures of the accompanying drawings, which are incorporated in and constitute a part of the specification. These drawings, together with the general description of the invention given above and the detailed description of the preferred embodiments given below, serve to explain the general principles of the invention.

FIG. 1 shows a perspective view of an exemplary embodiment of the present invention as viewed from the right rear side.

FIG. 2 shows a perspective view of an exemplary embodiment of the present invention as viewed from the left front side.

FIG. 3 shows a view of an exemplary embodiment of the present invention as viewed from the rear.

FIG. 4A shows a view of an exemplary embodiment of the present invention's cooler as viewed from the front of the cooler as mounted on a trailer.

FIG. 4B shows a view of an exemplary embodiment of the present invention's cooler as viewed from the left side of the cooler as mounted on a trailer.

FIG. 5 shows a flow chart that illustrates a process of operation of an exemplary embodiment of the present invention.

FIG. 6 shows an exemplary embodiment of the layout of a multi-well site use the present invention.

FIG. 7 shows an exemplary embodiment of the virtual remote monitoring of outputs and measurements of the present invention.

Many aspects of the invention can be better understood with reference to the above referenced drawings. The elements and features shown in the drawings are not to scale, emphasis instead being placed upon clearly illustrating the principles of exemplary embodiments of the present invention. Moreover, certain dimensions may be exaggerated to help visually convey such principles. In the drawings, reference numerals designate like or corresponding, but not necessarily identical, elements throughout the several views. Other features of the present embodiments will be apparent from the detailed description that follows.

### DETAILED DESCRIPTION OF THE DISCLOSURE

This detailed description is organized into two sections: first, a detailed discussion of the preferred embodiments of components of the cooler apparatus and system disclosed by the invention, and second a discussion of the basic operation disclosed by the invention.

Throughout this disclosure, components and features of the disclosed invention may be discussed with reference to more than one illustration. A particular component or feature is given the same numeral throughout this disclosure and the accompanying illustrations.

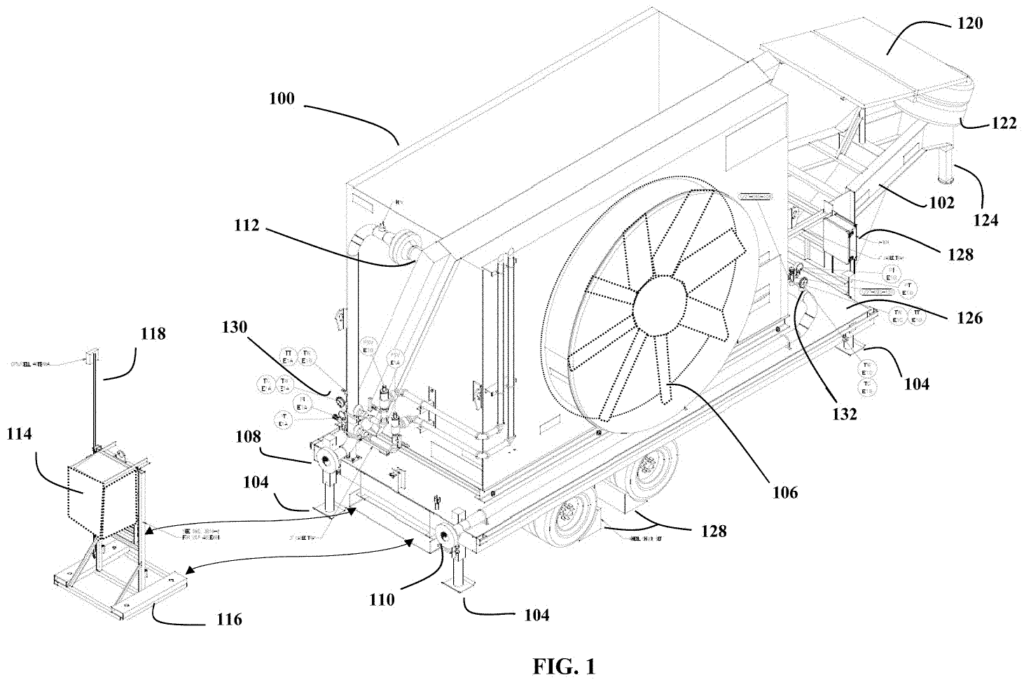

In a preferred embodiment shown in FIG. 1, a mobile cooler for use in heat exchange operations at an oil and gas well site comprises a cooler 100 mounted to a trailer 102, typically a gooseneck-type trailer, The trailer can be coupled to a vehicle, such as a standard pickup truck (not shown), by use of a standard hitch assembly (receiver/coupler) 124 and transported to the well or field site. The overall dimensions and weight of the exemplary cooler permit transportation of the trailer 102 to the well site without having to comply with stringent transportation regulations for a “wide-load.” In a preferred embodiment, the mounting surface 126 of the trailer 102 may be less than or equal to 20 feet, to accommodate the cooler and related equipment. The overall length of the trailer 102 in a preferred embodiment is approximately 28 feet; its overall width is 8 feet 6 inches or less; the overall height of the disclosed mobile cooler is under 14 feet (non-permit load limit for Texas), and approximate total weight of the trailer as depicted is approximately 22,500 lbs.—all to come within appropriate dimension and weight limits to avoid categorization as a “wide load” or “non-permit load” for transportation. One of ordinary skill in the art can understand and appreciate that even through the present embodiment describes a gooseneck trailer, the cooler system may be configured on any other functionally equivalent trailer and may be towed by any other appropriate vehicle, or may be mounted on a skid which may or may not be removable from a trailer. For example, the gooseneck trailer can be replaced by a flatbed trailer, subject to the possible application of wide load transportation requirements and weight limitations to this replacement trailer.

The trailer 102 may include one or more front and rear leveling jacks 104 to permit levelling and installation at its pre-determined location without the need for its placement on a pad or skid (although it may be placed on a pad or skid), avoiding the need for heavy machinery or a crane to lift it in place on site. The trailer may also include an assembly for attaching spare tires 122. In alternative embodiments, one skilled in the art will appreciate that equipment may be affixed to a skid or pad.

In alternative embodiments, one skilled in the art will appreciate that additional vessels, instrumentation, and equipment may be affixed to the trailer 102 as may be modified or lengthened, such as for example a scrubber and/or generator (not shown), within the scope of ordinary engineering practices. In such an embodiment, the trailer 102 may include bases, housings, or other connections suitable for receiving one or more of a generator, scrubber, instrumentation, and other equipment, and such equipment may be affixed to the trailer 102 by one or more pins, bolts, welds, plates, and the like.

In the preferred embodiment, substantially all of the piping and electrical connections to be discussed are affixed to, or otherwise pre-fabricated to be made-ready for operation on the trailer 102 upon arrival on the work site. In this manner the cooler system is adapted for “plug-and-play” deployment, installation, start-up and operation.

### The Cooler System

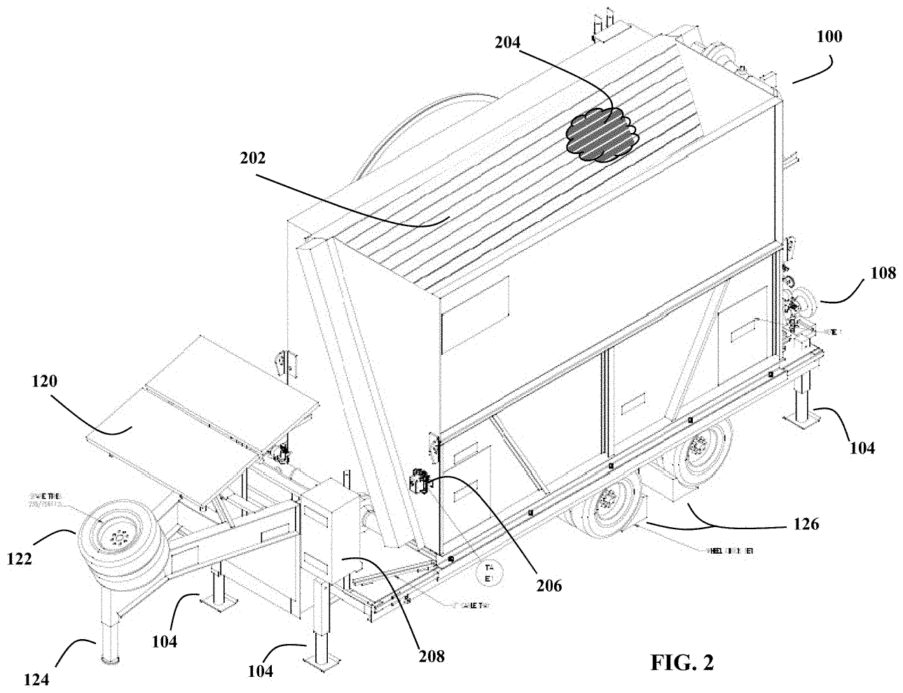

As depicted in FIGS. 1 and 2, the cooler 100 may be shaped generally as a rectangular box housing. The rectangular box shape may have two side walls, an open top (or alternatively a top wall (not depicted)), a bottom wall, a front wall, and a back wall. One or ordinary skill in the art can understand and appreciate that the enclosure can have any other appropriate shape without departing from the broader spirit of this disclosure. The cooler 100 is affixed to the mounting surface of the trailer 126 by one or more pins, bolts, welds, plates, and the like (not shown), as will be appreciated by one of ordinary skill in the art and normal engineering practices.

In a preferred embodiment, as depicted in FIGS. 1-4B, the cooler 100 itself is a commercially available electric motor driven cooler fan, for example, a Model EH Air-X-Changer manufactured by Harsco Industrial of Tulsa, Okla. (recently acquired by Chart Industries, Inc.). The Model EH Air-X-Changer has a typical design pressure of 1445 psi and design temperature range of 350/−10° F.

The cooler 100 includes customized piping 112 affixed to its housing by conventional means and normal engineering practices, with an inlet flange 108 coupled to one end of said piping 112, and an outlet flange 110 coupled to the opposite end of said piping 112. The piping is comprised of non-corrosive metal with fittings as will be appreciated by a person of ordinary skill in the art. The inlet and outlet flanges 108 and 110 may be of various diameters, including 4-inch 900# RF in a preferred embodiment. In the preferred embodiment the piping 112 is designed to ASME B31.3.

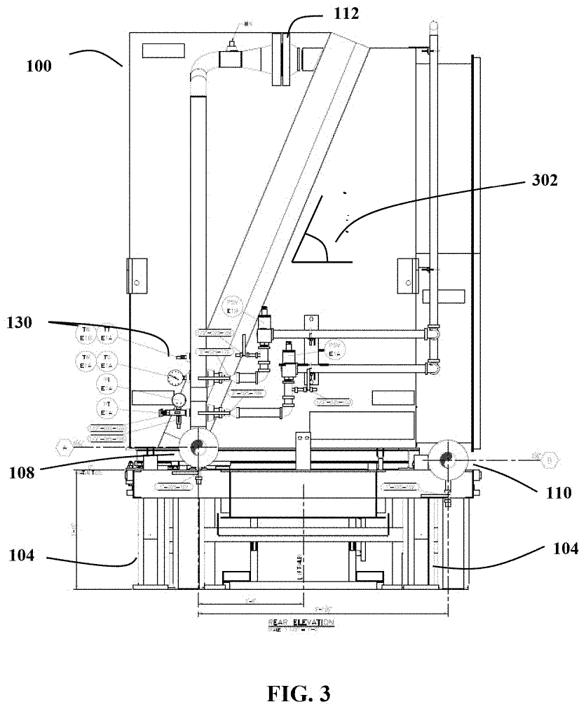

In the exemplary embodiment, the cooler piping 112 is coupled to cooling tubing (depicted in cutaway 204 in FIG. 2), which is used as the cooler's heat exchanger. The cooling tubing 204 of the exemplary embodiment may be arranged as a tubular coil which is configured in a serpentine manner as multiple passes in multiple rows, wherein each row is stacked on top of the other. A person of ordinary skill in the art will recognize that the cooling tubing 204 can be in a variety of dimensions and configurations, and adapted to carry a variety of fluids, including hydrocarbon gas and liquids, such as natural gas, in other representative embodiments. The cooling tubing 204 may be comprised of a metal with good heat conductive properties and positioned and arranged in a bundle and/or a serpentine manner oriented along a plane angled in relation to a cooling fan 106 and the mounting surface of the trailer 126. In a preferred embodiment that angle is 45 degrees 302 as depicted in FIG. 3. The cooling tubing 204 may include attached fins to accommodate and provide increased heat transfer (not depicted), as will be recognized by a person of ordinary skill in the art.

In a preferred embodiment depicted in FIG. 2, a mechanical vent louvering system 202 comprised of a series of louvers extending horizontally is attached to the cooler 100 adjacent to the outlet side of the cooling tubing 204. The louvering system is adjustable and may comprise manually operated louvers, or automatic controlled louvers.

In a preferred embodiment the vent louvering system 202 comprises aluminum louvers, such as those manufactured by AirFlo Cooling Technologies of Tulsa, Okla. As will be appreciated by a person of ordinary skill in the art, the louvers may be opened and closed through an automated louver control 208, including using pneumatic or electric air motor actuators, for example, such as those manufactured by the Triac Division of A-T Controls, Inc. of Cincinnati, Ohio (not shown). In an alternative embodiment, manually operated vent louvers may be furnished with a spring loaded manual operating handle which may be adjusted for the preferred open or closed position. The vent louvering system 202 is connected to the cooler housing using a connecting linkage, which also connects the actuating rods of the louvers to the actuator (not shown).

The vent louvering system 202 may be adapted to be adjusted, automatically or manually as discussed, wherein the opening or closing of the louvers can control the air flow passage out of the cooler 100 opposite the cooling tubing 204. In other embodiments (not shown), a top end of the rectangular box comprising the cooler 100 may include further vent louver systems and/or relief vents as will be appreciated by one of ordinary skill in the art.

As shown in FIG. 1, a side wall of the cooler box in the exemplary embodiment includes an enclosure for a mechanical cooling fan 106 that is used to create an air flow into the cooler 100 by suction of air from the atmosphere into the cooler. As will be recognized by a person of ordinary skill in the art, the forced air flow created by the operation of fan 106 is blown over the cooling tube bundle 204 and discharged out of the vent louvering system 202 to perform heat exchange between the fluid travelling through the cooling tubing 204.

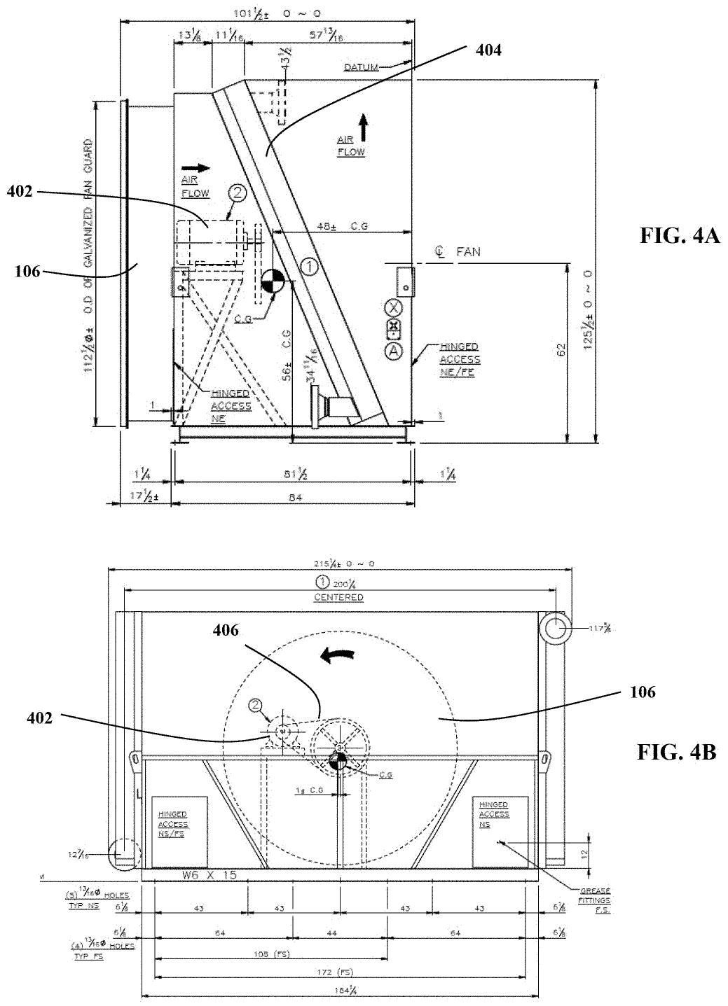

As shown in FIGS. 4A and 4B, the cooling fan 106 is rotated by an electric motor 402 attached to the cooler. In an exemplary embodiment, the electric motor 402 is a 30 hp, 1800 rpm VFD compatible totally enclosed, fan-cooled (TEFC) electric motor such at manufactured by Toshiba International Corporation. The electric motor 402 is coupled to the fan 106 by a v-belt or other similar linkage as will be appreciated by one of ordinary skill in the art.

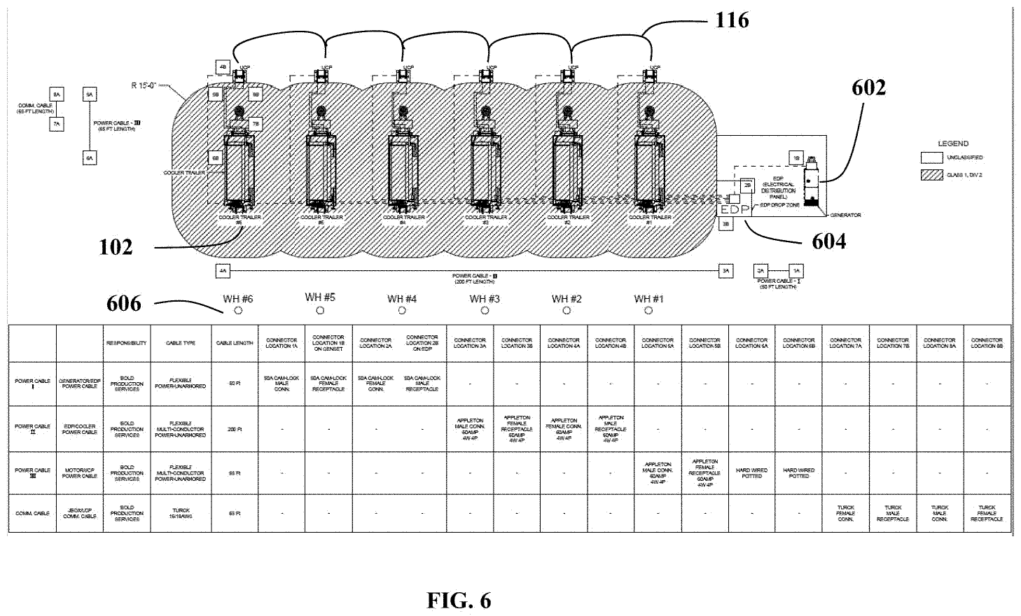

In a preferred embodiment as shown in FIG. 1 the cooling system includes a Unit Control Panel (UCP) 114 mounted on a UCP support frame 116. During transportation the UCP support frame 116 is mounted and secured on the rear of the trailer. Once on location, the UCP support frame 116 can be removed and positioned in a suitable location, typically located 15 feet in front of the trailer's goose neck as depicted in FIG. 6. Typically, a fork lift is the recommended and safest way to remove and transport the UCP support frame 116. The UCP 114 is then connected to the cooler system with detachable communication and power cables as depicted in FIG. 6.

In a preferred embodiment, the UCP 114 contains a variable frequency drive (VFD) with temperature controller (not shown) used to control the electric motor 402 based upon a predetermined outlet temperature setpoint. The UCP 114 monitors the outlet temperature of the fluid stream, and accordingly adjusts the speed of the electric motor 402 via the VFD to control the rotation of the fan 106 and thereby control the amount of air flow moving across the cooler tubing 204, represented in cubic feet per minute (CFM). In an exemplary embodiment, the VFD is a standard VFD product such as a Teco-Westinghouse® VFD with a temperature controller, such as a SOLO® temperature controller. The temperature controller typically has PLC functionality in order to utilize the PID loop control logic.

The PLC controller is capable of monitoring inlet and outlet fluid temperatures through temperature sensors 130 and 132, respectively shown in FIG. 1, which are communicatively attached to the cooler piping 112, which permits precise control of the cooling output through the VFD controlled electric motor 402 and the automated vent louvering system 202 as discussed in more detail below. In further embodiments, the system may include various additional sensors and gauges placed in proximity to the inlet and outlet of the piping 112 to provide a measure of temperature and pressure of the fluid stream as depicted in FIGS. 1-3.

In a preferred embodiment, the cooler 100 may be protected by means of an adjustable vibration sensor (not shown) which is designed to monitor and shut down the electric fan motor 402 if excessive vibration is detected.

In a preferred embodiment, a solar powered battery backup power supply is contained in a solar panel battery box 208 as shown in FIG. 2. All electrical designs of the preferred embodiment of the invention are in specification to National Electric Code (NEC) standards as may be amended from time to time.

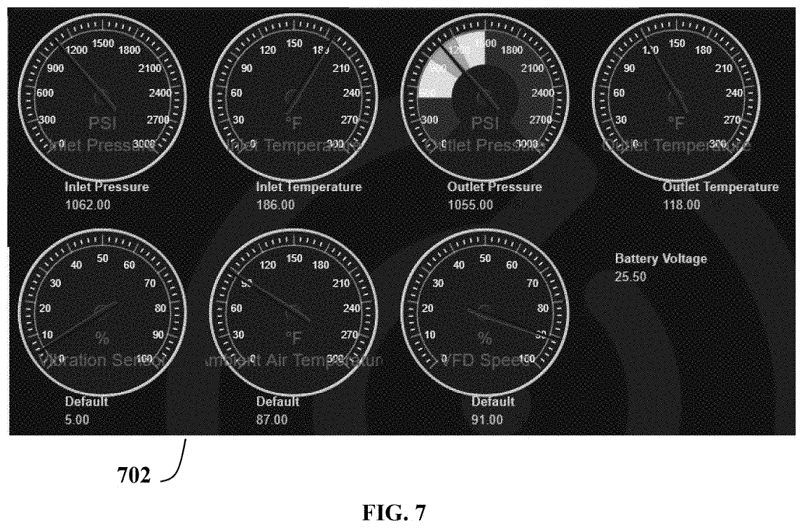

The preferred embodiment includes a PLC/cellular telemetry module and monitoring system (not shown) with antenna 118 which module may be contained in the UCP box 114 and communicatively connected to the VFD and cooler system control modules to permit control and monitoring of the cooler system operation. As illustrated in FIG. 7, the telemetry module and monitoring system allows use of software, including incorporating a dashboard and/or graphical user display 702, for various measurements from the cooler system control module (not shown) for remote viewing (e.g. over the internet. Alternatively, a satellite-based communications module could be used in place of the cellular telemetry module.

In addition, in further embodiments the cooler can include one or more solar panels 120 as depicted in FIGS. 1-2. The solar panels 120 may be used to provide an alternate source of energy for any appropriate operation of the cooler. For example, the solar panels 120 can be configured to provide an alternate energy source for charging batteries located in a solar panel battery box 208, which batteries provide electrical energy associated with operating the 24 VDC cooler louver system 202 and associated communications systems.

### Engine Driver/Generator

As depicted in FIG. 6, an engine driver 602, such as an electrical generator, can be coupled to a cooler 100 or a series of coolers to supply electrical power for operations. In one embodiment, the engine driver 602 can run on natural gas produced from a well. For example, natural gas that is to be cooled by the cooler 100 may be used as fuel for operations of the engine driver 602. In other embodiments, the engine driver 602 may run on liquid fuel. Grid power can also be utilized if an electric power pole is nearby. The type of engine driver may be chosen based on the specific operational environment, or application of the cooler and/or power requirements for the application of the cooler. One of ordinary skill in the art can understand that the engine driver 602, which also may be mounted on other embodiments of a trailer 102, or on a separate trailer, may be chosen subject to the possible application of “wide load” transportation requirements and weight limitations.

In a preferred embodiment, the engine driver 602 may be a gas-powered generator such as manufactured by Hipower Systems of Olathe, Kans. with weather protective enclosure and sound reduction. One of ordinary skill in the art can understand and appreciate that the generator can be replaced by any other appropriate engine driver that can drive the cooler without departing from the broader scope of the present disclosure. Alternatively, if 480 VAC power is otherwise available on location, the cooler 100 can utilize that source for power.

In one embodiment, the engine driver may include a digital display board and an electronic control circuit (not shown). The engine driver may also be monitored remotely using the PLC/cellular-based telemetry system (not shown) previously discussed. Other example features that can be controlled using the electronic control circuitry can include speed of the engine driver, safety parameters of the engine, oil level, load bank and water temperature. An exemplary embodiment of the present invention may include an auto start control module for the generator, for example an auto start control module as sold by Deep Sea Electronics USA of Rockford, Ill. (not shown).

One preferred embodiment illustrated in FIG. 6 includes an electrical distribution panel (EDP) 604 to allow electrical power to be distributed from the generator 602 to a single or to multiple coolers 100. The EDP 604 includes electrical connections and breakers as will be appreciated by a person skilled in the relevant art. The EDP 604 is mounted on a support stand and may be transported in the bed of a standard pick-up truck or trailer. A fork lift can be used to lift the EDP or workers can maneuver and slide the EDP into the back of a pick-up truck or trailer and secure it for transportation.

In further embodiments, the cooler may include a gas leak detection system (not shown).

In further embodiments, the cooler may include an OSHA approved work platform scaffolding system (not show) which may be installed on one or more sides of the trailer 102 as required. In a preferred embodiment, there are two platforms required for each side of the trailer.

### Mobile Cooler Set-Up and Operation

Once located at the work site, the trailer 102 with the cooler system 100 can be parked on leveled, solid ground. Wheel chocks 126 as illustrated in FIGS. 1 and 2 are typically used to secure the trailer's wheels to prevent movement. The trailer's front and rear leveling jacks 104 permit levelling and installation at its pre-determined location without the need for its placement on a pad or skid, avoiding the need for heavy machinery or a crane to lift the cooler 100 in place. In some embodiments, the trailer 102 may be rested on a concrete pad or any other type of pad, if such a pad is available to the site. The exemplary cooler 100 is designed to operate while mounted on the trailer 102 and need not be dismounted for operational purposes. The trailer 102, or a series of trailers are typically set with its back end toward the well location 606 as shown in FIG. 6.

Once the trailer is placed at the proper location, it may be unhitched from the vehicle and further leveled using the leveling jacks 104.

The height of the trailer may be adjusted to minimize the exposure of the cooler to the ground underneath. For example, when the trailer bed is above the ground, an air gap between the trailer bed and the ground may avoids direct exposure to radiated heat from the ground, thereby improving an effectiveness of the cooler.

The solar panels 120 are adjusted and pointed nearest to the south as possible and set at an angle of approximately 60°. The panels may be secured in place and the operator may confirm the charging rate is acceptable.

The UCP support frame 116 is removed from the trailer 102 and positioned in a suitable location, typically located 15 feet in front of the trailer's goose neck, to satisfy class 1, Division 2 requirements, as depicted in FIG. 6. A grounding rod is installed in the ground that is connected to the unit and the telemetry antenna pole 118 is raised. All power cables (for example Armored 480-3 phase) and communication cable hook ups from the J-Box 128 to the UCP 114 and UCP 114 to the EDP 604 are made as depicted in FIG. 6. The EDP 604 is then connected to the generator 602 (or a power pole), which may be stand alone, or located on a separate trailer. Electrical equipment is grounded in place and secured.

The exemplary set-up process includes making up production inlet and outlet connections by coupling production piping from a wellhead or other inlet source, such as a water disposal system (not shown) that will be transporting the fluid to be cooled to the inlet flange 108 of the cooler, and coupling the outlet flange 110 of the cooler to an output pipeline for either recirculation to achieve further cooling and or for further transporting cooled fluid. In some embodiments, the inlet/outlet flanges 108 or 110 of the cooler 100 may be coupled to a separator or other preliminary or post-cooling processing equipment. A separator may be used to separate free liquids from gas once the gas is cooled by the cooler.

Once the cooler 100 or coolers are set-up as shown in FIG. 6, and all typical and routine inspections and checks made, production piping is attached to the inlet and outlet flanges, 108 and 110 respectively, and checked for leaks, and any alarms are cleared, the system may be started for operations. A breaker in the EDP 604 will be closed to supply power to the load bank and UCP 114. The cooler 100 may be switched on by a activating a start button configured on control panel (not shown) on the UCP 114, powering up the UPS and telemetry control system. One of ordinary skill in the art can understand and appreciate that the start mechanism using push button can be replaced by other manual as well as automatic start mechanisms without departing from a broader spirit of the present disclosure.

The desired output temperature setting is set using the temperature controller on the UCP box 114. The VFD is placed into an “auto” mode so that it can monitor the outlet temperature of the cooler with temperature sensors located on the cooler piping 112 and respond accordingly, as discussed in more detail in the Specific Operation of the Preferred Embodiment section below. When activated, the cooler 100 cools fluids flowing through the cooler tubing 204 by air cooling with the fan 106 as referenced in FIGS. 1, 2 and 6.

Once hot fluid from the inlet production piping enters the cooling tubing 204, the fluid will pass through the entire length of the cooling tubing 204 that is arranged in coils as described above. As the fluid stream proceeds through the coils of the cooling tubing 204, air is blown over the cooling tube by the fan 106, and through the resulting heat transfer, the temperature of the fluid decreases until it reaches the outlet where it is directed via the outlet flange 110 to production piping and then on to other processing equipment if desired and once desired processing and cooling is achieved, eventually to a main pipeline or a sales facility. The preferred embodiment of the system is designed for the UCP to monitor low temperature conditions below the setpoint temperature and automatically reduce fan speed to zero then closes the vent louver system 202 if required. All vital functions of the cooler system are monitored through the PLC/telemetry system, which, as discussed, allows for remote monitoring and control.

By way of an example, as illustrated in FIGS. 1, 2 and 6, gas from a wellhead 606, may be transported through production piping through the inlet flange 108 of the cooler and through the cooling tubing 204. Further, the outlet flange 110 may be coupled to other production piping that carries the fluid exiting from the cooling tube after the fluid has been subjected to a heat exchange process. Provided the air flowing over the cooling tubing 204 is at a lower temperature than the temperature of the fluid in the cooling tubing 204, heat may be exchanged from the fluid in the cooling tubing 204 to the air flowing over the cooling tubing and thereby cooling the fluid via convective heat transfer.

As described above, in a preferred embodiment, the cooler is designed such that, the air flow enters horizontally and is diverted vertically towards the atmosphere to the opening at the top of the cooler 100. One of ordinary skill in the art will appreciate that the forced air-cooling method as described herein can be replaced by any other appropriate cooling method without departing from the broader spirit of the present disclosure.

### Specific Operation of the Preferred Embodiment

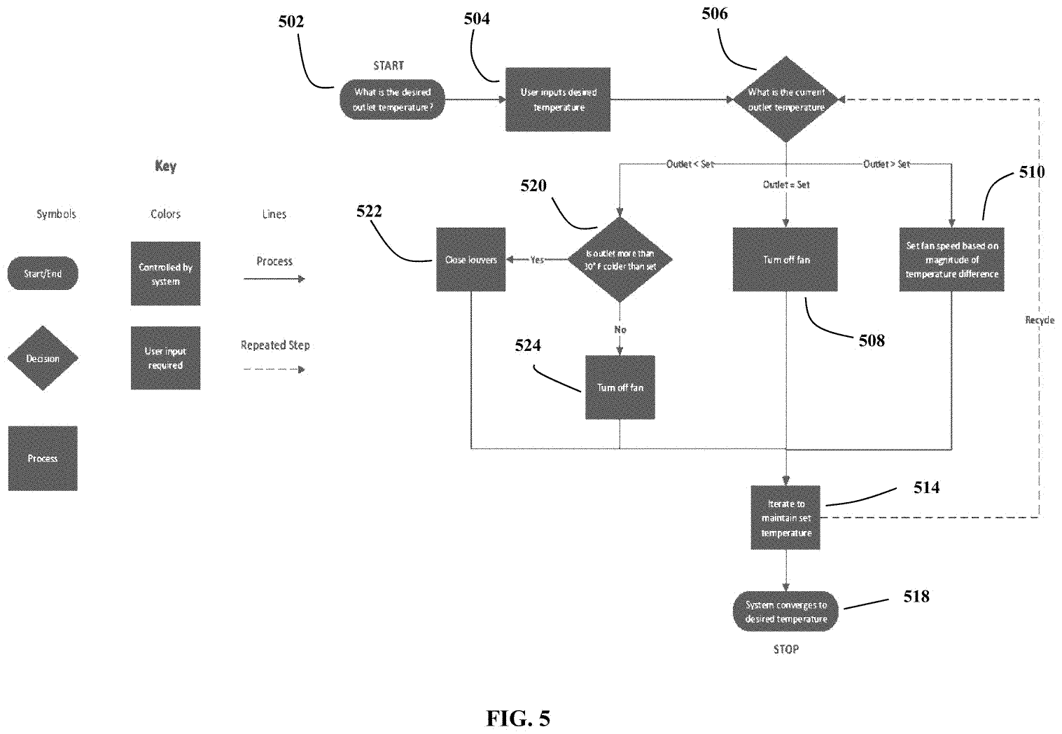

FIG. 5 illustrates a flow chart that demonstrates a process of operation of the cooler system, according to certain exemplary embodiments of the present invention.

Once the cooler system is set up as described above, and the generator (or alternate power source as previously described) is turned on, power is supplied to the UCP 114. For normal cooler operation the following describes how the system functions:

The temperature controller (inside the UCP box 114) is powered on and the desired outlet fluid temperature 502 is set by the user by inputting a setpoint temperature on the temperature controller 504. The cooler is placed into an “auto” mode via the UCP 114 so that it can monitor the outlet temperature of the fluid 506 from the outlet temperature sensor 132 and respond accordingly. Once the outlet temperature, as monitored by the outlet temperature sensor 132 on the cooler piping 112, is greater than or equal to whatever the setpoint temperature is, the UCP 114 will initiate the closure of a set of contacts which complete a circuit to begin the process to start the electric motor 402. The electric motor 402 will then go into start mode where its starter will engage and the electric motor 402 will begin to rotate. The contacts on the UCP 114 also open the circuit for automatic opening of the mechanical louver system 202.

Once the electric motor 402 has started it will go into a safety time delay, such as a 1-minute delay. The UCP 114 monitors the system during the delay to ensure that all the voltages, engine speed and other outputs are stable prior to operation.

Once the delay has expired, the UCP will send a signal to the VFD to raise or lower the fan speed 510 based upon the difference between the setpoint and the outlet temperature of the fluid as monitored by the outlet temperature sensor 132 on the cooler piping 112. While the outlet fluid temperature remains higher than the setpoint, the VFD will increase the fan 106 speed to force more airflow over the cooling tubing 204. As the outlet temperature decreases closer to the setpoint the VFD will cause the electric motor 402 to slow down, thereby decreasing the fan's 106 rotational speed 514.

Once the outlet fluid temperature falls below the setpoint 520 the contacts in the UCP 114 will disengage the circuit. Once this happens, the VFD will go into a time delay, such as a 1-hour countdown. If at the end of the time delay, the outlet fluid temperature has not risen above the setpoint the electric motor 402 will automatically shut down 524, with the UCP 114 continuing to monitor the outlet temperature. The electric motor 402 will remain shut down until the outlet fluid temperature rises above the setpoint, at which point the electric motor 402 will restart and the foregoing process will start over again 514. Alternatively, when the system is placed in the “manual” mode, the electric motor 402 will continue to run and will not shut down under a low temperature condition.

If the UCP 114 is placed in the low ambient temperature mode, once the outlet temperature is less than or equal to whatever the set point is, the UCP 114 will monitor whether the outlet temperature falls below a predetermined offset from the setpoint (e.g. 30° F. colder than set point) 520.

If the outlet fluid temperature drops below the predetermined offset from the setpoint, then the contacts on the UCP 114 will open the circuit for automatic 522 closing of the mechanical louver system 202 to minimize heat loss over the cooler tubing 204 from air passing through the cooler.

### Multi-Well Pad Site Operations

In the multi-well configuration as illustrated in FIG. 6, any plurality of coolers 100 can be installed on a single site servicing a number of well-heads at the location. Each cooler system can operate autonomously from the other.

As shown in the exemplary system in FIG. 6, six cooler trailers 102 are spaced as close as 15′ apart from each other, and 30′ from each well-head 606 producing gas and/or fluids desired to be cooled. Power cables (for example Armored 480-3 phase) and communication cable hook ups are set up as previously discussed for each cooler 100, and are connected to the UCP 114. Power cables are run from the UCP to the EDP 604, which is connected to the generator (or other power source) 602. Start up and operations for each cooler 100 are as previously discussed. As a person skilled in the art can appreciate, required power, being pole power or generation power can be sized depending on the overall system requirements and any desired contingency requirements.

In summary, a person of skill in the art will recognize that this detailed description discloses an exemplary mobile cooler system invention. The terms “invention,” “the invention,” “this invention,” and “the present invention,” as used herein, intend to refer broadly to all disclosed subject matter and teaching, and recitations containing these terms should not be misconstrued as limiting the subject matter taught herein or to limit the meaning or scope of the claims. From the description of the exemplary embodiments, equivalents of the elements shown therein will suggest themselves to those skilled in the art, and ways of constructing other embodiments of the present invention will appear to practitioners of the art. Therefore, the scope of the present invention is to be limited only by the claims that follow. Further, the specification and drawings are to be regarded in an illustrative rather than a restrictive sense.

Having described presently preferred embodiments of the invention, it may be otherwise embodied within the scope of the following claims.

What is claimed is:

1. A mobile cooler system, comprising:
a trailer having a plurality of leveling members to permit level installation of the trailer at a site;
a cooler configured on the trailer operable to change the temperature of a fluid passing through the cooler;
an engine driver coupled to the cooler operable to drive a fan coupled to the cooler; and
a variable frequency drive module communicatively coupled to said engine driver and operable to control said engine driver at variable speeds.

2. The mobile cooler system of claim 1, wherein the cooler further comprises:
cooling tubing configured on the cooler and arranged in a serpentine manner, wherein the cooling tubing is oriented on a plane at an angle to the fan;
piping and an inlet flange coupled to one end of the cooling tubing;
piping and an outlet flange coupled to the other end the cooling tubing; and
said fan operable to provide forced-air across the cooling tubing for a heat exchange operation.

3. The mobile cooler system of claim 1, further comprising a vent louver system coupled to the cooler and configured substantially on a plane at an angle to the fan to control airflow moving past the cooling tubing.

4. The mobile cooler system of claim 1, further comprising a remote monitoring and telemetry system communicatively coupled to the variable frequency drive module.

5. The mobile cooler system of claim 1, further comprising a solar panel configured on the trailer to provide an alternative energy source for power.

6. The mobile cooler system of claim 1, wherein the combined height from the ground of the cooler mounted on the trailer is less than 13 feet and 6 inches.

7. The process of cooling a fluid using a fan-driven air-cooling system, comprising:
setting a desired temperature setpoint;
circulating a fluid stream through cooling tubing having an inlet and an outlet;
monitoring the outlet temperature of said fluid stream;
operating a fan to blow air on said cooling tubing based upon the difference between the outlet temperature of said fluid stream and the desired temperature setpoint;
operating a louver system to permit air blown by said fan past said cooling tubing to exhaust to the atmosphere;
decreasing the speed of said fan as the difference between the outlet temperature of said fluid stream and the desired temperature setpoint decreases;
increasing the speed of said fan as the difference between the outlet temperature of said fluid stream and the desired temperature setpoint increases;
cycling off said fan when said outlet temperature of the fluid stream is less than or equal to the setpoint;
closing said louver system if the outlet temperature drops below a predetermined offset from the setpoint; and
resuming said fan operation if the outlet temperature increases above the setpoint.
